(19) United States
(12) Patent Application Publication
(10) Pub. No.: US 2014/0151073 A1
(43) Pub. Date: Jun. 5, 2014

(54) Stalk Folding and Breaking Device

(71) Applicant: Titan International, Inc., Quincy, IL (US)

(72) Inventor: Maurice Taylor, Naples, FL (US)

(21) Appl. No.: 13/916,365

(22) Filed: Jun. 12, 2013

Related U.S. Application Data
(60) Provisional application No. 61/658,663, filed on Jun. 12, 2012.

(51) Int. Cl. A01D 75/18

(52) U.S. Cl. CPC A01D 75/18
USPC 172/1; 172/833

(57) ABSTRACT

A system and method for preventing stubble damage to agricultural implement tires is disclosed. The system can comprise a plurality of drag chains mounted in advance of tires traversing a field. The drag chains may be disposed by a plurality of hanging support chains to suspend the drag chains. The system may also comprise a plurality of chain assemblies separating the hanging chains and at least one mounting bracket, wherein the chain assembly is mounted to the agricultural implement so as to suspend the support chains and drag chains ahead of the front wheels of the implement.

### CROSS-REFERENCE TO RELATED APPLICATION(S)

This application claims priority to U.S. patent application Ser. No. 61/658,663 filed Jun. 12, 2012 which is incorporated herein by this reference.

### FIELD OF THE INVENTION

The system relates generally to agricultural implements. More specifically, the system comprises a method and apparatus for protecting tires by bending plant stalks down before driving an agricultural implement over them.

### BACKGROUND OF THE INVENTION

Combines, tractors, and more specifically, their tires, are costly to buy and maintain. Modern practice and no-till farming has led to the use of lower-pressure tires that are generally softer than their predecessors. These softer tires present great advantages to the farmer, but are not without their drawbacks.

With the development of new hybrid corn and bean varietals, the stalks of these and other plants have become increasingly rigid and sharp. These increasingly rigid stalks have created a host of new issues for the agricultural implements used to plant, harvest and transport crops, particularly by being caught in tire tread, causing stubble damage, irregular wear, and punctures of the implement's tires.

While various methods have been proposed to approach the problem of stubble damage, they have been costly and lacked durability. Therefore, there is a need in the art for an inexpensive apparatus that allows the farmer to traverse the fields with a reduced risk of stubble damage and the like to his or her costly tires. Although other apparatuses have been developed to address this problem, they tend to be hydraulic or more complicated in design, and thus are more expensive to produce and maintain. Further, the simplicity of the system allows a single apparatus to be used with a variety of different agricultural implements, rather than be specifically tailored to one implement, thus providing savings for the user.

### BRIEF SUMMARY OF THE INVENTION

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

One object of the present system is to provide an apparatus that allows the farmer to bend or break the stalks and stubble of crops prior to passing the wheels of an agricultural implement over them.

A further object of the system is to provide a method for protecting the tires of an agricultural implement from excessive wear and tear caused by increasingly rigid and sharp corn stalk stubble.

### BRIEF DESCRIPTION OF THE DRAWINGS

The features and advantages of the invention are explained in more detail in the subsequent detailed description with reference to the embodiments illustrated in the attached drawing figures, in which like reference numerals denote like elements and in which FIGS. 1-5C illustrate some embodiments of the system.

FIG. 1A is a perspective schematic of an exemplary embodiment of the system.

FIG. 1B is a headlong schematic of an exemplary embodiment of the system.

FIG. 2A is a perspective schematic of an exemplary embodiment of the system.

FIG. 2B is a headlong schematic of an exemplary embodiment of the system.

FIG. 3A is a perspective schematic of an exemplary embodiment of the system.

FIG. 3B is a headlong schematic of an exemplary embodiment of the system.

FIG. 4A is a perspective view of an exemplary embodiment of the system as applied to a combine, as seen from the left rear.

FIG. 4B is a close-up perspective view of the embodiment of FIG. 4A.

FIG. 4C is a close-up perspective view of the embodiment of FIG. 4A, with the combine head raised.

FIG. 5A is a perspective view of yet another exemplary embodiment of the system.

FIG. 5B is a side view of yet another exemplary embodiment of the system.

FIG. 5C is another perspective view of yet another exemplary embodiment of the system.

FIG. 6 shows an example tire having stubble damage.

### DETAILED DESCRIPTION

The system generally consists of an apparatus for knocking over or otherwise bending stalks of a crop prior to being driven over by an agricultural implement.

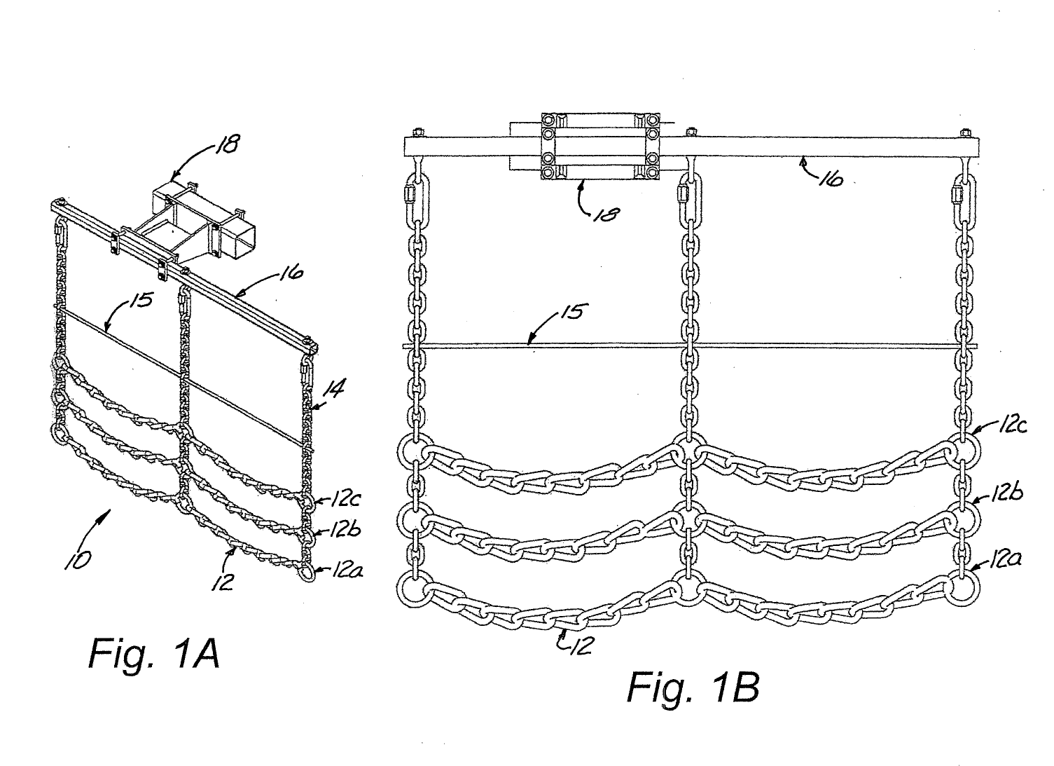

Turning to the figures, and as shown in FIGS. 1A-1B, an exemplary embodiment of the system 10 is comprised of one or more drag chains 12a, 12b, 12c attached to support chains 14, held in place by a spacer rod disposed distally from the chain assembly 16 on the support chains, such that the support chains 14 hang at sufficient width so as to provide drag chain region 12 coverage for the width implement's tires despite being contorted in the direction of a point while in motion, as would be understood by one of skill in the art.

In certain exemplary embodiments, the drag chains 12a, 12b, 12c are twisted chains, and the support chains 14 are straight link chains, though other embodiments are clearly possible. While a triplet of drag chains 12a, 12b, 12c per drag region 12 are shown in the figures, other configurations are possible. A plurality of drag regions are also disposed, and any number of such regions may be most practical for an individual application.

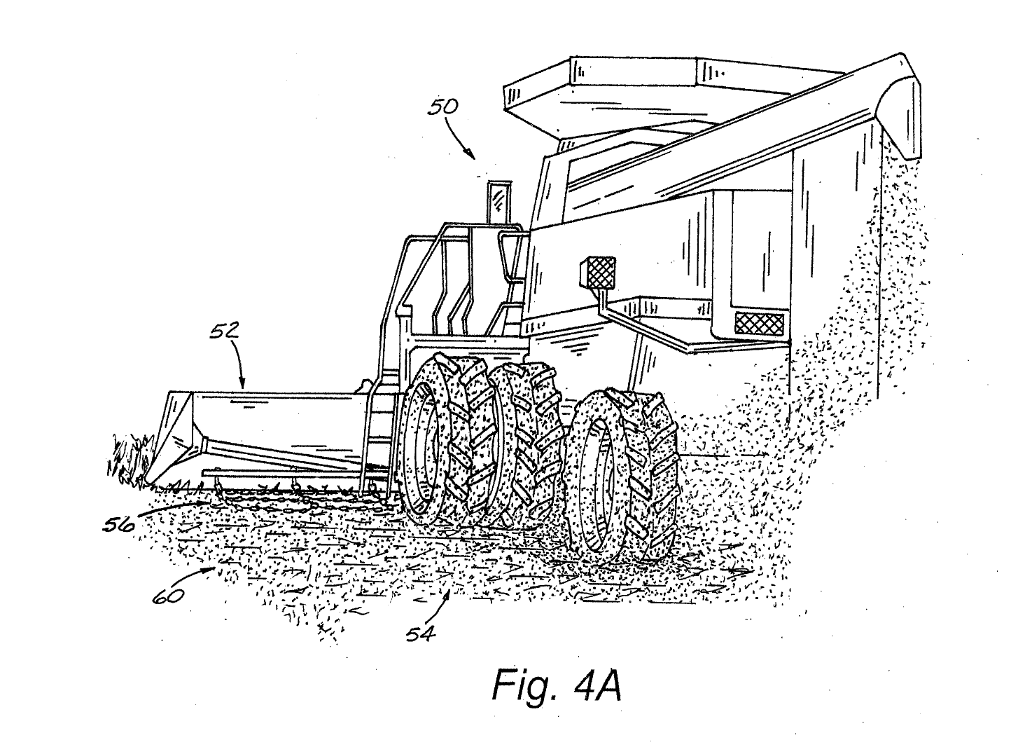

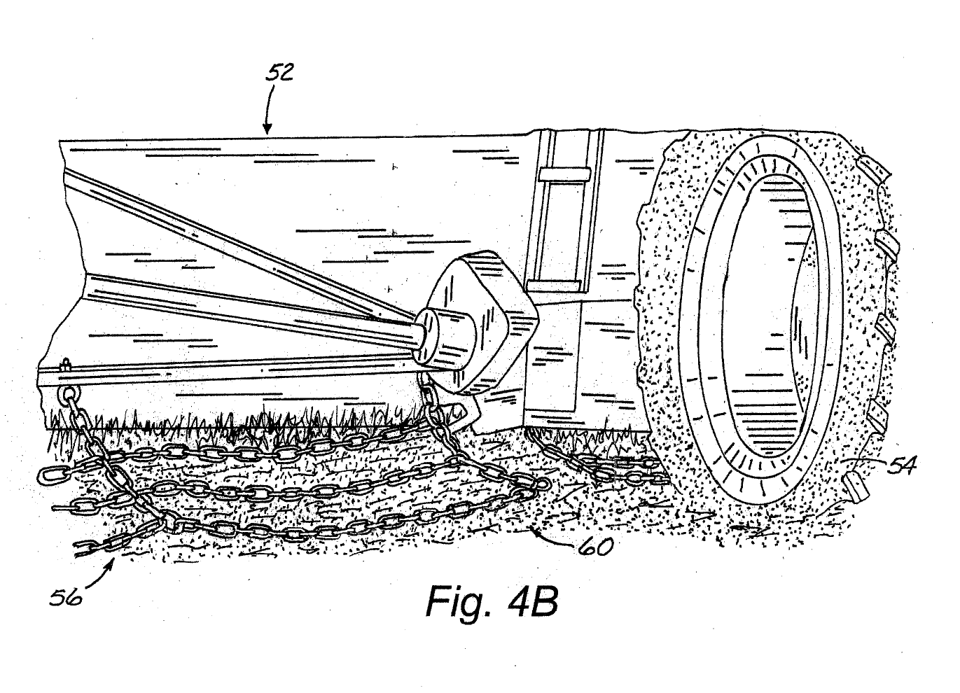

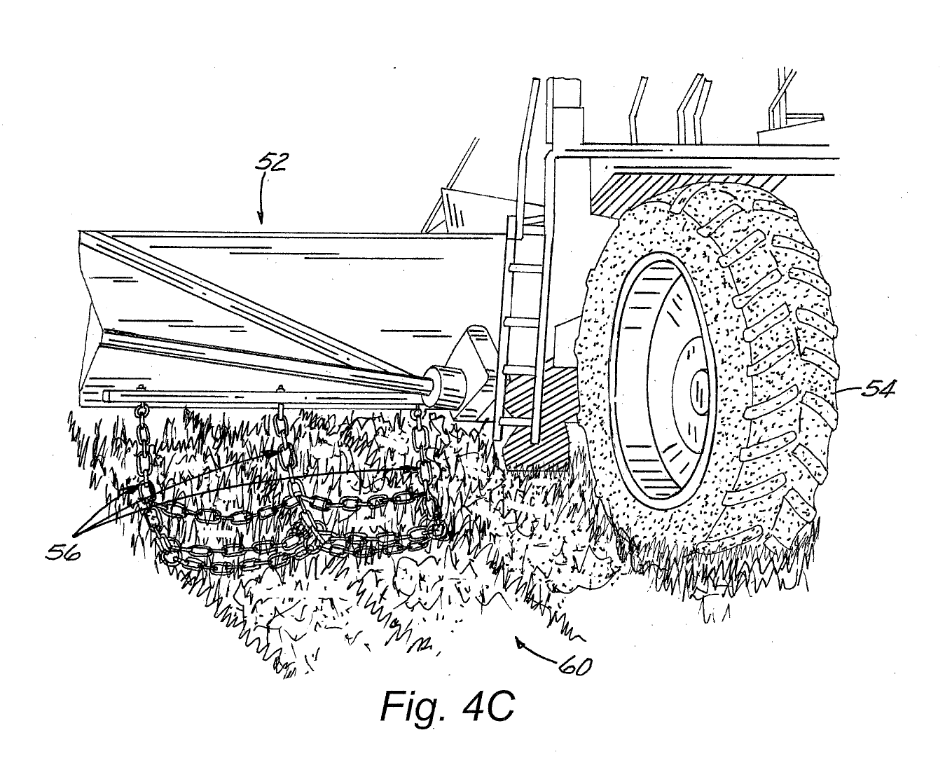

In certain exemplary embodiments, and as shown for example in FIG. 1A, the chain assembly 16 is mounted to a base assembly 18, the base assembly being attached to the mounting bracket, which is in turn mounted to the implement in advance of the tires, such as, for example, mounting to the combine head frame (as shown in relation to FIGS. 4A-4C). The base assembly 18 may also be mounted directly to the agricultural implement or in a variety of other methods of attachment, as would be apparent to one of skill in the art. Bolts, U-bolts, nuts, screws, welds and the like can all be employed to attach the chain assembly to the mounting bracket or to the implement directly. In certain other embodiments, the system may be mounted so as to be retractable.

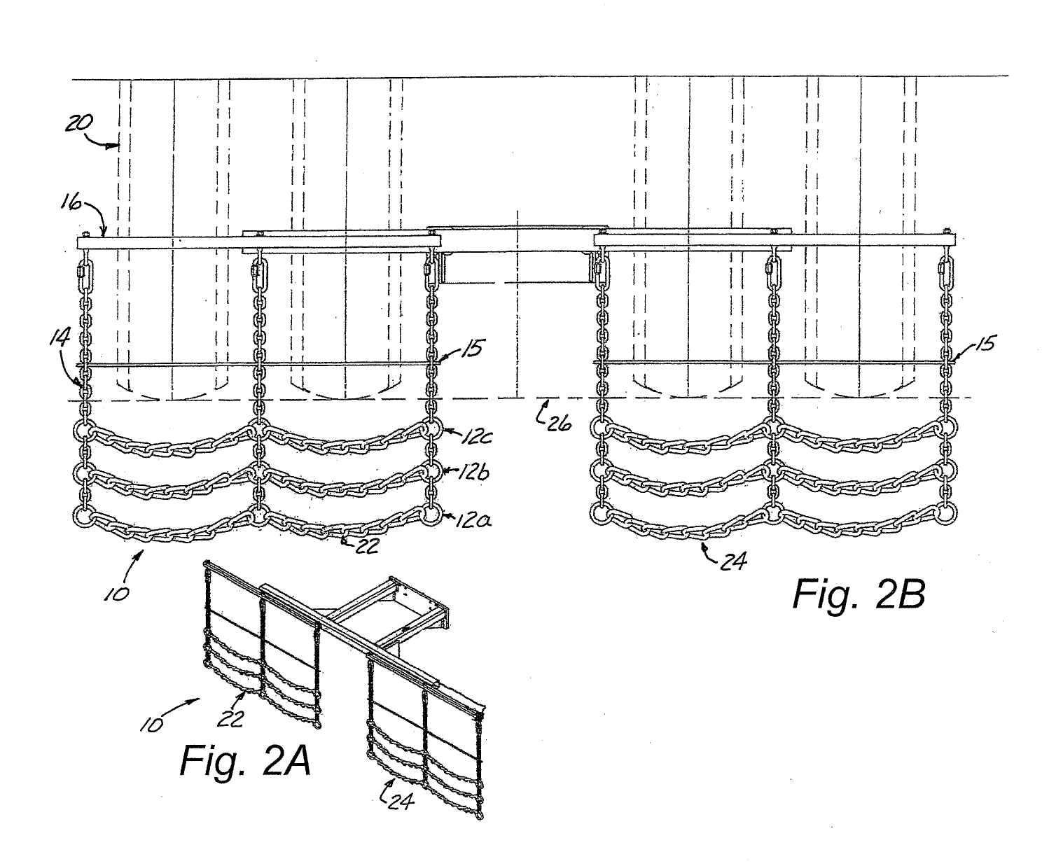

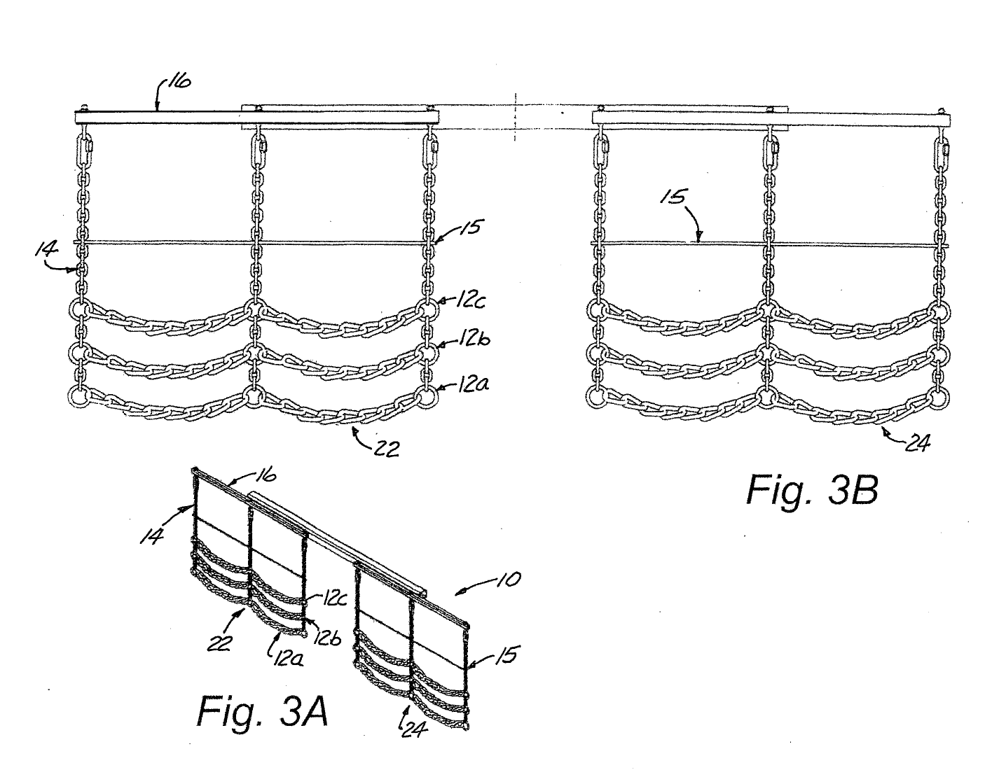

As shown in FIGS. 2A-4B, certain exemplary embodiments mount to the front of an agricultural implement 50, ahead of the implement tires 20. These implements can be combines, tractors, grain carts and the like. In certain exemplary embodiments, the system comprises two distinct sets dragging regions 22, 24, though other embodiments are possible depending upon the configuration of the host implement.

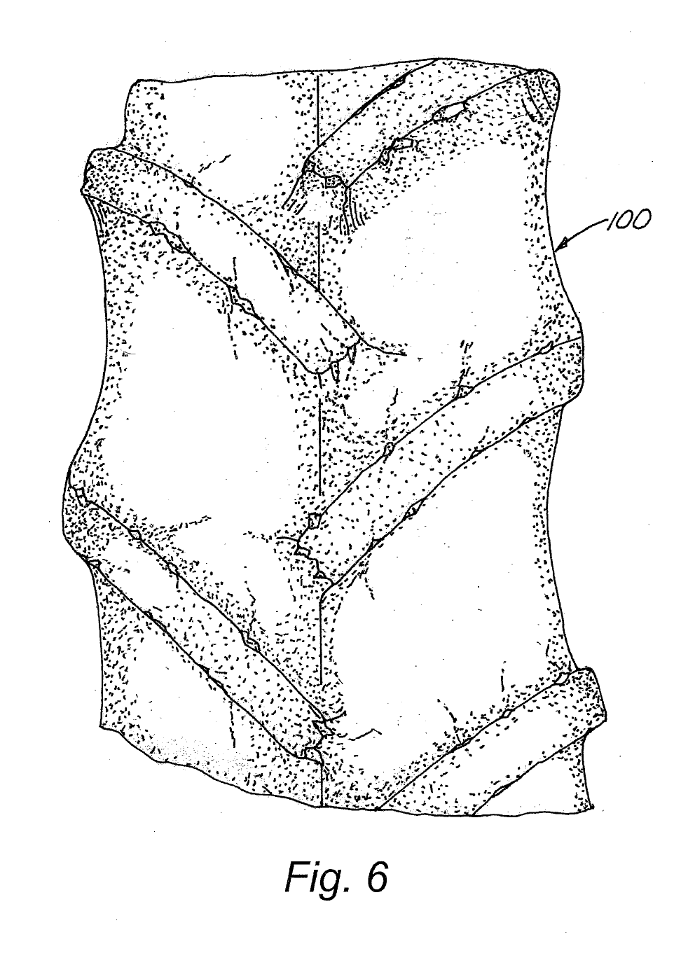

As best shown in FIG. 2B, the individual drag chains 12a, 12b, 12c are configured to hang below the ground horizon 26, so as to drag along the ground and bend, fold, or break plant stalks and other obstacles or debris as the tractor, combine, or grain cart passes through the field. With these stalks and other debris removed as threats to the tires, the tires suffer less stubble damage 100 (as shown in FIG. 6) and therefore last longer.

As best shown in FIGS. 4A-4B, in operation, the exemplary embodiments of the system operate to place the drag chains 56 on the ground in front of the tires of an agricultural implement, such as a combine, tractor, grain cart or other vehicle 50. In the embodiment depicted in FIGS. 4A-4B, a combine 50 having a combine head 52 and multiple tires 54 is depicted. Other configurations are possible. As would be apparent to one of skill in the art, in certain embodiments the system is mounted to the rear—relative to the direction of travel—of an implement, such as a combine head, as is depicted in FIGS. 4A-4C.

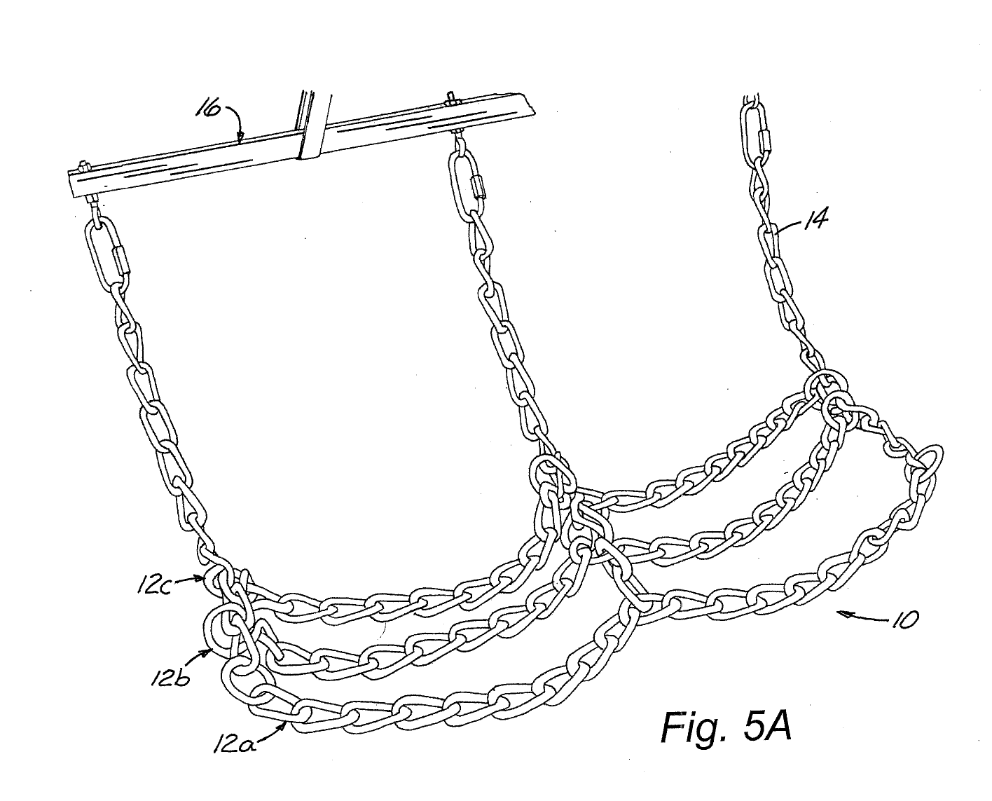

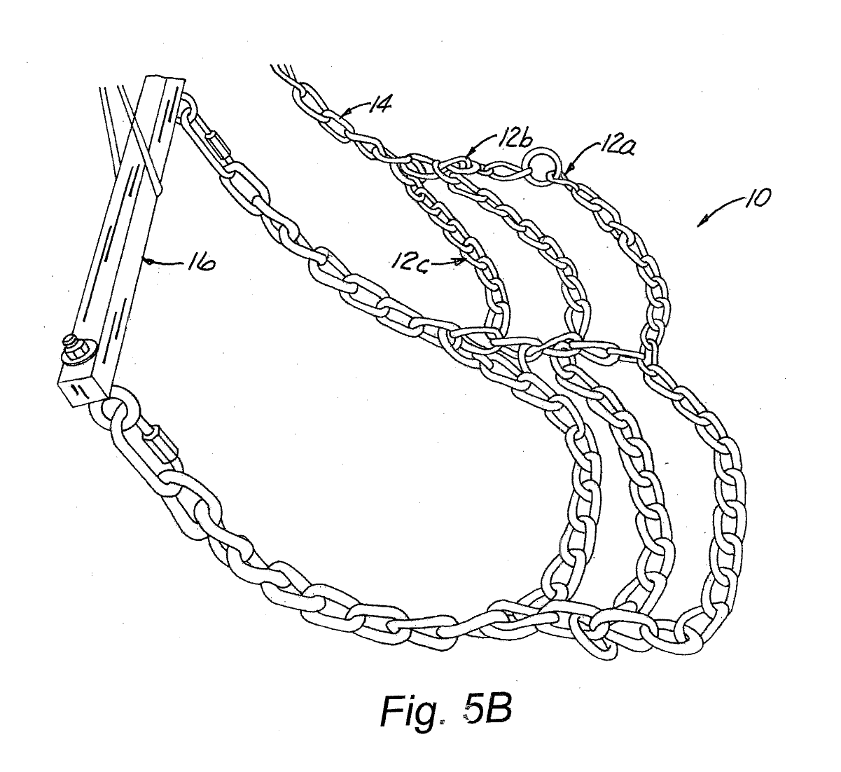

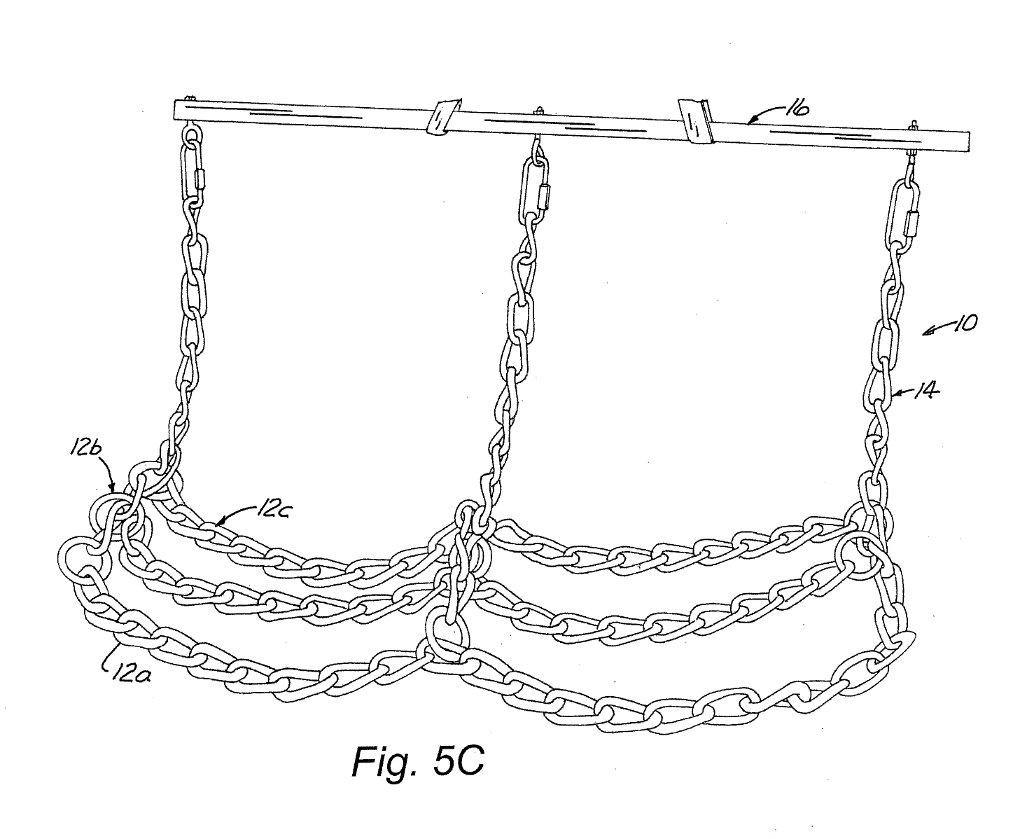

As also depicted in FIGS. 4A-5B, certain embodiments of the system comprise drag chains 56 which act to bend, fold, or break the stalks of the underlying crops 60 out of the way of the approaching tires 54. This bending, folding, and breaking acts to reduce or eliminate stubble damage to the tires, as is depicted in FIG. 6. This apparatus and method of operation thus acts as a means of protecting the soft tires commonly used in farm equipment from the stubble damage often cause by modern hybrids.

As shown in FIGS. 1A-1B and 5A-5C, in certain exemplary embodiments each of the multiple individual drag chains 12a, 12b, 12c will drag across the stalks as the agricultural implement drives across the field, thereby repeatedly applying force to the stalks and bending, folding, or breaking them down prior to being crossed by the wheels of the implement. Though three sets of drag chains are shown in this embodiment, one of ordinary skill in the art would recognize that other embodiments are possible. Further, it would be apparent to one of skill in the art that the weight of the chains is important, and the selection of both the drag and hanging chains would be done so as to maximize the force applied to the stalks. In certain exemplary embodiments, the drag chains are upwards of 50, 60 or 70 pounds per foot. Other embodiments are of course possible.

In exemplary embodiments, the mounting of the apparatus to the corn head frame, mounting bracket, main frame of the grain cart, or other mounting device is done so as to leave sufficient distance before the front tires of the implement that the drag chain regions 12, while the vehicle is in motion, do not interfere with the operation of the implement. For example, should three chains be used at a specific speed, the overall distance from the uppermost mounting of the hanging chain to furthest extension of the center of the drag chain should not equal or exceed the hypotenuse of the triangle formed by the mounting of the hanging chain and the front horizon of the foremost tire, for risk that the chain would be drawn under the lead tire. One of skill in the art would recognize the preferable configurations necessary.

Although the present invention has been described with reference to certain exemplary embodiments of the system, persons skilled in the art will recognize that changes may be made in form and detail without departing from the spirit and scope of the invention. It is therefore understood that various modifications may be made to the embodiments of the presently disclosed retraction system. The above description should not be construed as limiting, but merely illustrative of the variations described herein.

I claim:

1. An apparatus for reducing damage to tires mounted ahead of a the tires on an agricultural implement, comprising:
a. a drag chain region comprising at least one drag chain;
b. a plurality of hanging support chains suspending the drag chain;
c. at least one chain assembly separating the hanging support chains, such that the drag chain region is separated from the chain assembly by the hanging support chains; and
d. a mounting bracket, wherein the chain assembly is mounted to the agricultural implement so as to suspend the support chains and at least one drag chain ahead of the tires of the implement.

2. The apparatus of claim 1, further comprising at least one spacer rod disposed substantially parallel to the chain assembly between two or more hanging chains and operationally integrated with the hanging support chains.

3. The apparatus of claim 1, further comprising a base assembly, wherein the base assembly is structurally integrated with the mounting bracket and chain assembly.

4. The apparatus of claim 1, wherein the hanging support chains are straight link chains.

5. The apparatus of claim 1, wherein the at least one drag chain is a twisted chain.

6. The apparatus of claim 1, wherein the at least one drag chain weighs at least 50 pounds per foot.

7. A method of preventing agricultural implement tire damage from crops, comprising:
a. providing an agricultural implement;
b. providing at least one agricultural implement tire;
c. providing a mounting apparatus affixed to the agricultural implement;
d. providing support chains hanging from the mounting apparatus;
e. providing drag chains suspended by the support chains so as to be disposed ahead of the at least one agricultural tire in the direction of travel;
f. providing at least one spacer rod disposed between the support chains so as to maintain sufficient width in the drag chain so as to provide chain ground coverage ahead of the implement tire; and
g. traversing a field or other crop area with the agricultural implement such that the drag chains are passed across crops ahead of the agricultural implement tires so as to break and bend the crops and prevent damage to the tire.

8. A method of preventing stubble damage, comprising:
a. providing a motorized vehicle further comprising a plurality of tires and a mounting apparatus disposed in front of the tires relative to the normal direction of travel;
b. disposing one or more drag chains weighing at least 50 pounds per foot from the mounting apparatus, such the drag chains are disposed across the ground in front of the tires; and
c. reducing upright stalks in advance of the tires by dragging the drag chains over the stalks in the direction of travel.

9. The method of claim 8, further comprising providing support chains between the drag chains and mounting apparatus.

10. The method of claim 9, further comprising providing one or more spacer rods for spacing of the support chains.
